(19) United States
(12) Patent Application Publication
(10) Pub. No.: US 2006/0175847 A1
(43) Pub. Date: Aug. 10, 2006

(54) Magnetic doorknob with interchangeable design discs

(76) Inventor: Blair Cates Davis, San Antonio, TX (US)

Correspondence Address: Blair Cates Davis, 317 Thelma Drive, San Antonio, TX, 78212, US

(21) Appl. No.: 11/052,493

(22) Filed: Feb. 7, 2005

(51) Int. Cl. E05B 1/00

(52) U.S. Cl. 292/347

(57) ABSTRACT

A solid material doorknob which has been modified by boring a large circular recess into the face of the doorknob and adhering an adhesive-backed flat (sheet) magnet inside the recess so as to allow the attraction and arrest of a disc with a high ferrous (iron) content to which disc a design, texture, color, or all, may be applied prior to installation.

### BACKGROUND OF THE INVENTION

The present invention relates to doorknobs and more particularly to a solid material doorknob modified so that it is able accommodate an interchangeable design-embellished insert.

The following specific problems exist in the present state of technology regarding the use of conventional doorknobs:

A challenge exists regarding the use in or upon a doorknob face of a design pattern which has a specific and well-recognized orientation requirement. (By way of example, a five point star is generally recognized to be properly oriented when one of its points is directed in an upward direction.) The problem arises once a doorknob is screwed onto the spindle to a degree of tightness necessary to hold the doorknob snugly against the door. Once the doorknob is fully tightened onto its spindle, a design which is permanently affixed to the face of a doorknob may not be properly aligned in accordance with its commonly-recognized orientation requirement.

A second challenge exists for a user who desires to alter with ease the design, color, or theme of a doorknob. Using the current state of the art, the user may only make such an alteration by replacing the doorknob itself

### SUMMARY OF THE INVENTION

With regard to the challenge stated in [0002], above, it is the object of the present invention to remedy this problem by allowing a design-embellished disc to “float” upon or within the doorknob's face, utilizing the attraction and friction created between the flat magnet and the design-embellished disc, so that the design's orientation may be corrected once the doorknob itself has been tightened into place on its spindle. This invention allows the design-embellished disc to be rotated within the recess in the doorknob's face by using mild force from the user's fingers while also providing sufficient magnetic attraction to prevent the disc from being a.) rotated inadvertently during the course of the normal use of the doorknob and b.) accidentally discharged from the doorknob in the event the door is shut with force against its jamb.

With regard to the challenge stated in [0003], above, it is the purpose of this invention to allow the user to insert into a modified doorknob a wide variety of design-embellished discs to accommodate changes in the user's design tastes and requirements without the need of replacing the doorknob itself. The removal of the design-embellished disc from the recess is accomplished by the user's grasping or pinching the raised design (if any exists on the face of the disc) or by removing the doorknob from the spindle and sharply “bumping” the doorknob against the user's opposite palm; such force is sufficient to break the magnet's arrest of the disc.

The objects, features, and advantages of the present invention are best understood upon a review of the following detailed description and the accompanying drawings.

### DESCRIPTION OF THE DRAWINGS

Referencing the drawings:

FIG. 1 demonstrates a full scale front view of a solid material doorknob which, for purposes of the illustration, has a diameter of approximately 2¼ inches and which, for purposes of the illustration, has been modified by boring into the face of the knob a 1⅝″ straight-walled circular recess with a depth of ¼ inch.

FIG. 2 illustrates the side view of the doorknob, as modified according to the above description.

FIG. 3 illustrates the section view of the doorknob with the designed disc being held in place by the magnetic surface which has been adhered to the face of the recessed cavity in the doorknob.

FIG. 4 illlustrates an exploded view of all parts of the invention in which “A” illustrates the doorknob into which the recess has been bored; “B” illustrates the flexible flat magnet cut to a width of (scant) the diameter of the bored recess; and “C” illlustrates the high ferrous (iron) content disc onto which a design is affixed. (For purposes of this illustration, a five-point star has been selected for the design affixed to the disc, as shown in FIGS. 1 and 4).

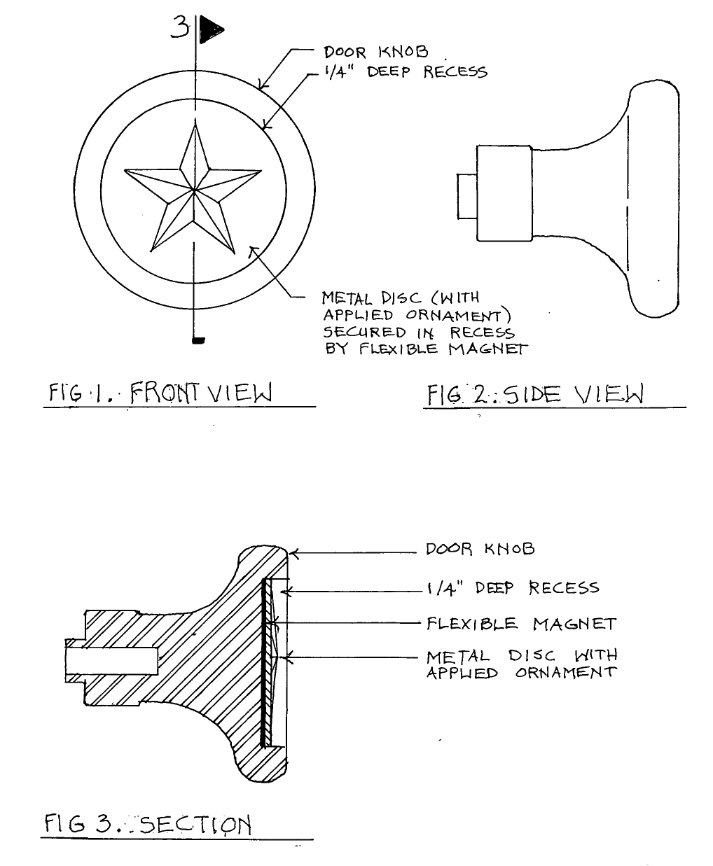

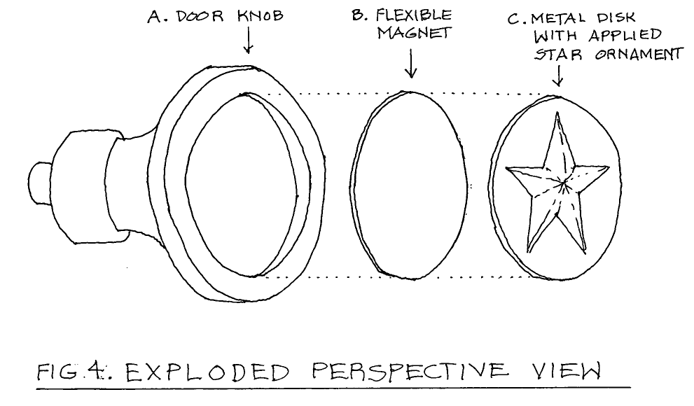

### DESCRIPTION OF THE INVENTION

This invention, as depicted herein, uses a doorknob which is comprised of a single cast piece of solid material, such as brass, steel, or iron. (For purposes of this application a doorknob with a front face diameter of approximately 2¼ inches has been selected.) The doorknob is modified by boring into its face a straight-wall circular recess. (For purposes of this application, a straight-walled circular recess of 1⅝ inches with a depth of ¼ inch has been selected.) A flexible flat magnet with an adhesive back is cut to the (scant) same width as the circular recess so that the flexible magnet fits snugly into the recess. The adhesive side of the flexible flat magnet is adhered to the surface face of the recess so as to give the recessed cavity the capability of attracting and arresting a flat disc which contains a high ferrous (iron) content. One side of the disc (the side which is visible to the viewer once the disc has been arrested by the magnet and sits in place inside the recessed area) provides an area upon which a design may be imprinted, painted, enameled, inlaid, or affixed, so that the design will be visible when the knob is viewed from the front. The designed-embellished disc may be rotated within the recess using mild force from the user's fingers so as to correct for any disorientation of the design once the shank of the doorknob has been screwed onto the spindle. The magnetic attraction between the magnet and the disc provide sufficient friction so that the design-embellished disc cannot be rotated inadvertently during the normal use of the doorknob, nor may the disc be dislodged from its seat when the door is shut against its jamb with normal force.

I claim:

1. A doorknob comprising: a single cast doorknob of solid material, such as brass, steel, or iron, into the face of which doorknob a straight-wall circular recess has been bored; into said recess an adhesive-backed thin flexible flat (sheet) magnet, cut to the (scant) same width as the circular recess, is adhered so as to give the recessed cavity the capability of attracting and arresting a flat disc which has a high ferrous (iron) content; and a flat disc with a high ferrous (iron) content which is capable of being attracted to, and arrested by, the thin flexible flat (sheet) magnet.

2. The manner of use and the application of using the adhesive-backed flexible flat (sheet) magnet of claim 1, wherein the adhesive-backed flexible flat (sheet) magnet is modified by reducing it in size and shape to the (scant) same width as the recess in the doorknob, as described in claim 1, and then utilized by adhering the adhesive-backed flexible flat (sheet) magnet to the doorknob, as modified, as described in claim 1.

3. The manner of use and the application of using a flat disc which has a high ferrous (iron) content, capable of being attracted to, and arrested by, the adhesive-backed flexible flat (sheet) magnet, as modified and adhered into the recess, as described in claim 1 and claim 2.

4. The manner of use and the application of using a flat disc, which has a high ferrous (iron) content, upon which a design has been imprinted, enameled, inlaid, or affixed to the disc so that the design is visible when the knob is viewed from the front.

5. The manner of use and the application of using a flat disc with a high ferrous (iron) content, as described in claim 1, claim 3, and claim 4, so that the disc may be rotated within the recess of the doorknob, as described in claim 1, by rotating the disc within the recess while using the attraction of the magnet to hold the disc in place within the recess.
